(19) United States
(12) Patent Application Publication
(10) Pub. No.: US 2024/0295223 A1
(43) Pub. Date: Sep. 5, 2024

(54) Automatic Folding Blade Type Fan Mounting Frame Structure

(71) Applicant: Zhongshan Miaowang Electric Co., Ltd., Zhongshan (CN)

(72) Inventor: Ziwei Yang, Loudi (CN)

(21) Appl. No.: 18/592,421

(22) Filed: Feb. 29, 2024

(30) Foreign Application Priority Data
Mar. 2, 2023 (CN) 202320377377.3

(51) Int. Cl. F04D 29/36; F04D 19/00

(52) U.S. Cl. CPC F04D 29/36; F04D 19/002

(57) ABSTRACT

An automatic folding blade type fan mounting frame structure includes a main machine, wherein the main machine is provided with a fan blade mounting frame. The fan blade mounting frame is provided with at least two mounting holes, and fan blade assemblies are arranged on the mounting holes of the fan blade mounting frame. The fan blade assembly includes blades. The fan blade mounting frame is provided with a folding structure. Tie rods are arranged between two adjacent fan blade assemblies. The fan blade mounting frame is provided with reinforcing convex ribs between two adjacent mounting holes. This fan structure improves the structural strength of the product and reduces frame deformation.

### TECHNICAL FIELD

The present utility patent specifically relates to an automatic folding blade type fan mounting frame structure.

### BACKGROUND

General fans have a rotating blade disc, and fan blades are arranged on the fan blades disc. When the fan blades rotate, the air forms an airflow to achieve the effect of generating wind and cooling. In order to solve the shortcomings of large space occupation, unsightly appearance, and easy accumulation of dust, the automatic folding blade fan was born. In order to solve the problems of traditional automatic folding blade fans such as complex structure and instability. In order to solve the above problem, persons skilled in the art created a new type of automatic folding blade fan. The reference application number of the issued patent is CN202121263776.4 and the name is an automatic folding blade fan. This kind of fan connects each fan blade assembly through a tie rod. The center line of the arc section of the tie rod is tangent to the center line of the straight section of another adjacent tie rod, so that the two adjacent rotating bases capable of rotating synchronously and reducing rotational resistance, making the fan blades fold more smoothly and the structure more solid and durable. However, in the subsequent product development, it was discovered that since the tie rod must mostly connect the two fan blade assemblies along a straight line, and the number of fan blade brackets on the product is set corresponding to the fan blade assembly, the pulling force generated by the tie rod is ultimately exerted on the two adjacent fan blade brackets, which causes that the fan blade brackets are easily stressed and slightly deformed. When the fan is working and the fan blade disc is rotating, and the deformation of the fan blade brackets can easily lead to unbalanced rotation of the fan blade disc, increase the amplitude of fan vibration, and cause shaking and noise.

The present utility patent is created based on the above-mentioned deficiencies.

### SUMMARY

The purpose of the present utility patent is to overcome the shortcomings of the existing technology and provide an automatic folding blade type fan mounting frame structure, which improves product structural strength, reduces bracket deformation, and improves product quality and service life.

The present utility patent is realized through the following technical solutions:

An automatic folding blade type fan mounting frame structure, includes a main machine, wherein the main machine is provided with a rotatable fan blade mounting frame, and the fan blade mounting frame is provided with at least two mounting holes distributed along the circumference, and fan blade assemblies capable of rotating relatively are arranged on the mounting holes of the fan blade mounting frame. The fan blade assemblies includes blades extending away from the rotation center so that when the fan blade mounting frame rotates, the fan blade assemblies expands outward under the action of centrifugal force when the fan blade mounting frame rotates. The fan blade mounting frame is provided with a folding structure that can fold the fan blade assemblies when it stops rotating. A tie rod is provided between two adjacent fan blade assemblies. The two ends of the tie rod are respectively connected to the eccentric positions of the two fan blade assemblies, so that each fan blade assembly can pull the adjacent fan blade assemblies to rotate synchronously when rotating. The tie rod includes a straight section and an arc section, a center line AB of the straight section and a center line BC of the arc section. When the fan blade is in the unfolded state, the center line BC of the arc section (52) of one tie rod (5) is tangent to the center line AB of the straight section (51) of the other adjacent tie rod (5). The fan blade mounting frame is provided with reinforcing convex ribs between two adjacent mounting holes. The reinforcing convex ribs are in the shape of a long strip and its two ends are respectively close to the two adjacent mounting holes.

According to the above-mentioned automatic folding blade fan mounting frame structure, the fan blade mounting frame is plate-shaped and is arranged with continuous flanges on its edges.

According to the above-mentioned automatic folding blade fan mounting frame structure, the fan blade mounting frame is a triangular plate, and the mounting holes are provided with three and are respectively located near the three vertices of the triangle. The fan blade mounting frame is provided with transitional convex ribs around the mounting holes. The transitional convex ribs and reinforcing convex ribs are alternately arranged and connected end to end to form a ring-shaped structure.

According to the above-mentioned automatic folding fan mounting bracket structure, the transition convex rib is an arc-shaped long strip structure, and the arc shape of the transition convex rib is concentric with the mounting hole.

According to the above-mentioned automatic folding blade fan mounting frame structure, the fan blade mounting frame is a circular plate, the mounting holes are provided with at least four, and the reinforcing convex ribs are arc-shaped long strip structures.

According to the above-mentioned automatic folding fan mounting frame structure, the reinforcing convex ribs are provided with a number of supporting convex ribs extending in the radial direction.

According to the above-mentioned automatic folding blade type fan mounting frame structure, the folding structure includes a rotating base connected to the fan blade assembly, the rotating base is connected to a return spring, and one end of the return spring is connected to rotating base and the other end is connected to the fan blade mounting frame.

According to the above-mentioned automatic folding blade fan mounting frame structure, the fan blade assembly further includes a sliding base connected to the blade, and the sliding base is arranged between the blade and the fan blade mounting frame.

According to the above-mentioned automatic folding blade fan mounting frame structure, a protrusion is provided in the middle of the fan blade mounting frame for connecting to the mounting boss of the main machine.

According to the above-mentioned automatic folding fan mounting frame structure, the fan blade mounting frame and the reinforcing convex ribs are an integrated structure formed by stamping of metal.

Compared with the existing technology, the present utility patent has the following advantages:

The shape of the reinforced convex ribs of the automatic folding blade fan of the present invention is roughly along the direction of the center line of two adjacent mounting holes, and the fan blade mounting frame is an integral structure. The reinforced convex ribs make the structural strength between the adjacent mounting holes being greatly improved, reduce the amount of deformation caused by the tensile stress generated by the tie rod, prevent imbalance rotation of the structure when the fan rotates due to structural deformation between the adjacent mounting holes, and minimizing the degree of shaking and noise when the product is working.

### BRIEF DESCRIPTION OF DRAWINGS

FIG. 1 is a perspective view of a fan according to Embodiment 1 of the present utility patent;

FIG. 2 is a first exploded view of the fan according to Embodiment 1 of the present utility patent;

FIG. 3 is a second exploded view of the fan according to Embodiment 1 of the present utility patent;

FIG. 4 is a three-dimensional schematic view of the tie rod according to Embodiment 1 of the present utility patent;

FIG. 5 is a perspective view of the fan according to Embodiment 2 of the present utility patent;

FIG. 6 is an exploded view of the fan according to Embodiment 2 of the present utility patent;

FIG. 7 is a three-dimensional schematic view of the tie rod according to Embodiment 2 of the present utility patent.

### DESCRIPTION OF EMBODIMENTS

Below is a further detailed description of the present utility patent based on the drawings:

The orientations described in the specification of the present utility patent, such as “upper”, “lower”, “left”, “right”, “front”, “rear” are based on the orientation of the drawings and are used to facilitate the description of each component. The purpose of the relationship is not to indicate the unique or absolute positional relationship between the various components. It is only one of the implementation methods for realizing the utility patent and is not a limitation on its embodiments.

### Embodiment 1

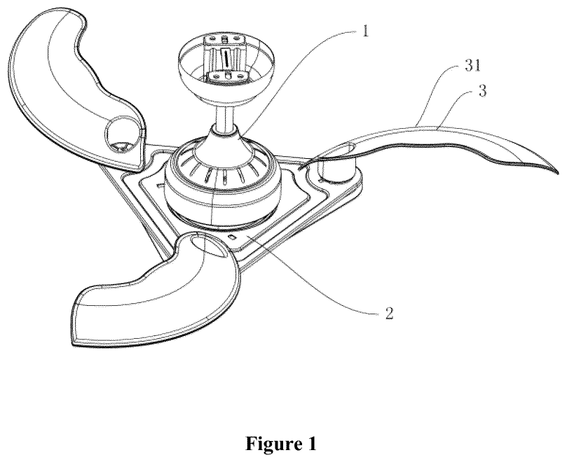

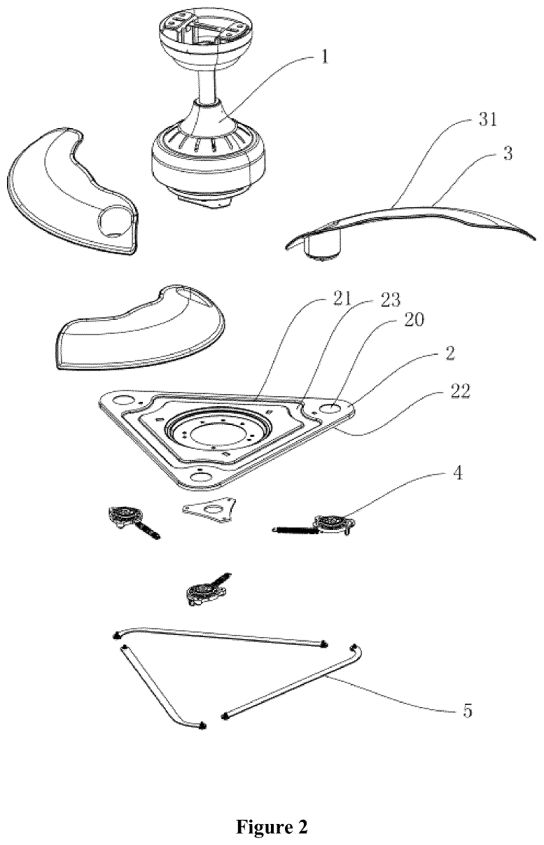

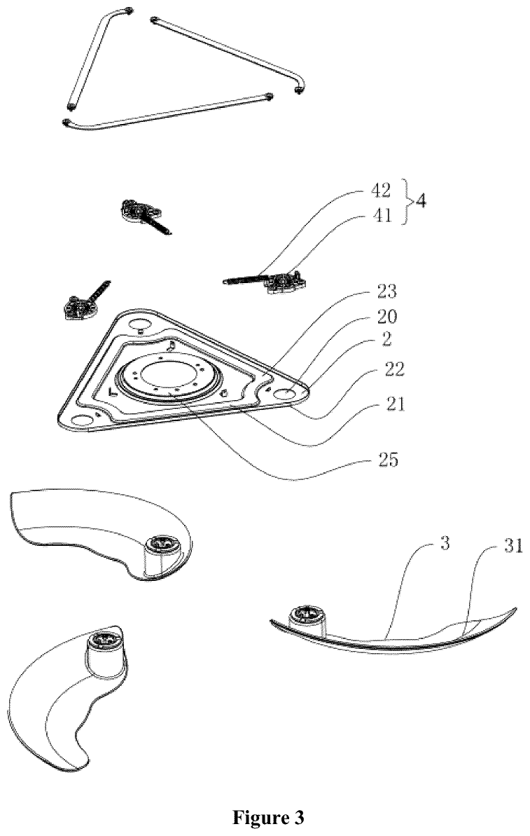

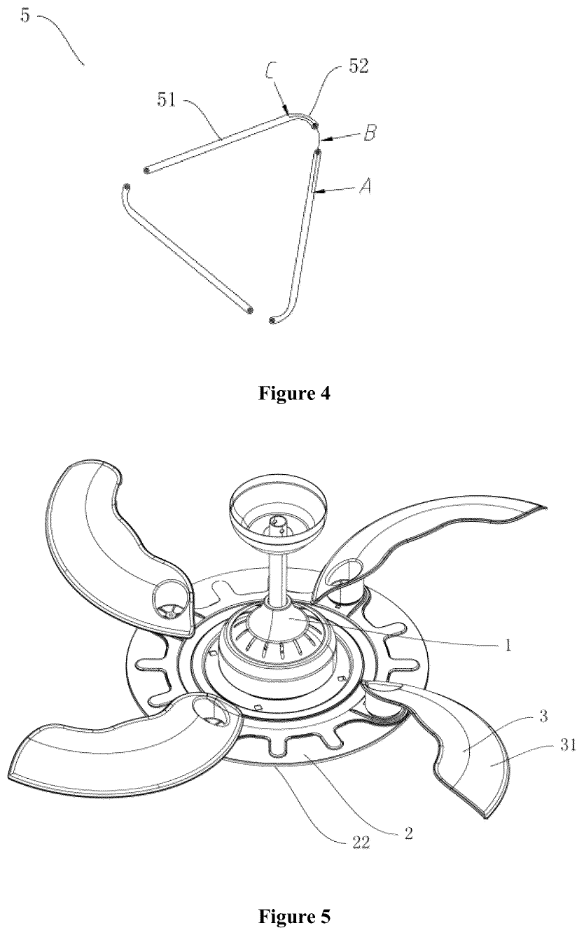

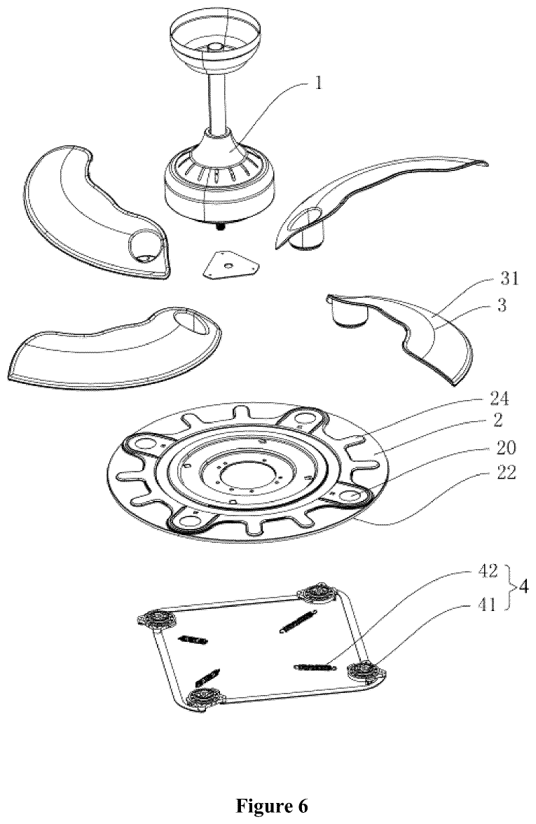

As FIGS. 1 and 2 shown, an automatic folding blade type fan mounting frame structure includes a main machine 1. The main machine 1 is provided with a rotatable fan blade mounting frame 2. The fan blade mounting frame 2 is provided with at least two mounting holes 20 distributed along the circumference. Fan blade assemblies 3 capable of rotating relatively are arranged on the mounting holes 20 of the fan blade mounting frame 2. As FIGS. 3 and 4 shown, the fan blade assembly 3 includes blades 31 extending away from the center of rotation so that the fan blade assembly 3 expands outwards under the action of centrifugal force when the fan blade mounting frame 2 rotates. The fan blade mounting frame 2 is provided with a folding structure 4 capable of folding the fan blade assemblies 3 when it stops rotating. There is a tie rod 5 between two adjacent fan blade assemblies 3. The two ends of the tie rod 5 are respectively connected to the eccentric position of the two fan blade assemblies 3, which enables each fan blade assembly 3 to pull the adjacent fan blade assemblies 3 to rotate synchronously when rotating. The tie rod 5 includes a straight section 51 and an arc section 52, a center line AB of the straight section 51 and a center line BC of the arc section 52. When the fan blades are in the unfolded state, the center line BC of the arc section 52 of one tie rod 5 is tangent to the center line AB of the straight section 51 of the other adjacent tie rod 5. The detailed structure can be referred to the issued patent application number CN202121263776.4, which is titled as an automatic folding blade fan. The fan blade mounting frame 2 is directly connected to the motor shaft of the main machine 1, or the motor shaft is connected to a mounting plate and then connected to the fan blade mounting frame 2 through the mounting plate. As shown in the figures, the motor shaft of the main machine 1 is connected to a mounting plate. The mounting plate is connected to the fan blade mounting frame 2 by drilling holes and installing fastening screws. The fan blade mounting frame 2 is provided with reinforcing convex ribs 21 between two adjacent mounting holes 20. The reinforcing convex ribs 21 are in the shape of long strip and have both ends close to the two adjacent mounting holes 20 respectively. Since the tensile stress generated by the tie rod 5 is roughly along the direction of the center line of the two adjacent mounting holes 20, the shape of the reinforcing convex ribs 21 is also roughly along the center line direction of two adjacent mounting holes 20, and the fan blade mounting frame 2 is an integral structure, the reinforcing convex ribs 21 make the structural strength between the adjacent mounting holes is greatly improved, reduce amount of deformation caused by the tensile stress generated by the tie rod 5 and prevents the unbalanced rotation of the structure when the fan rotates due to the structural deformation between the adjacent mounting holes 20, and minimizes the shaking and noise caused by the product during operation.

In order to improve the deformation resistance of the fan blade mounting frame 2, the fan blade mounting frame 2 and the reinforcing convex ribs 21 are preferably an integrated structure formed by stamping of metal plate. Preferably, the fan blade mounting frame 2 can be made with continuous flanges 22 around the edges. As a preferred structure, as FIGS. 1 to 4 shown, the fan blade mounting frame 2 is a triangular plate. There are three mounting holes 20 and they are respectively located near the three vertices of the triangle. The fan blade mounting frame 2 is provided with transition convex ribs 23 around the mounting hole 20. The transition convex ribs 23 and the reinforcing convex ribs 21 are alternately arranged and connected end to end to form a ring-shaped structure, which not only improves the overall performance of bending strength of the fan blade mounting frame 2 and easy to manufacture.

Preferably, the transition convex rib 23 is an arc-shaped long strip structure, and the arc shape of the transition convex rib 23 is concentric with the mounting hole 20, so that the side surface of the rotating base 41 can be close to and parallel to the side surface of the transition convex rib 23, which makes it difficult for the rotating base 41 to swing when rotating. The side surface of the transition convex rib 23 serves to guide and support the rotating base 41 and improve the structural stability and firmness.

Specifically, as FIGS. 3 and 4 shown, the folding structure 4 includes a rotating base 41 connected to the fan blade assembly 3. The rotating base 41 is connected to a return spring 42. One end of the return spring 42 is connected to the rotating base 41 and the other end is connected to the fan blade mounting frame 2. In this way, when the fan blade mounting frame 2 rotates, the blades 31 will expand outward due to centrifugal force, and the rotating base 41 connected to it will follow the rotation and pull the return spring 42 to stretch and generate tensile stress at the same time. When the fan blade mounting frame 2 gradually stops rotating, the centrifugal force generated by the blade 31 gradually becomes smaller. The tensile stress of the return spring 42 can pull the rotating base 41 to return, and at the same time the fan blade assembly 3 is folded.

In order to reduce the friction between the blade 31 and the fan blade mounting frame 2, the blade assembly 3 further includes a sliding base 32 connected to the blade 31. The sliding base 32 is arranged between the blade 31 and the fan blade mounting frame 2.

In order to facilitate the installation of the fan blade mounting frame 2 on the motor shaft of the main machine 1, a protrusion is provided in the middle of the fan blade mounting frame 2 for connecting to the mounting boss 25 of the main machine 1.

### Embodiment 2

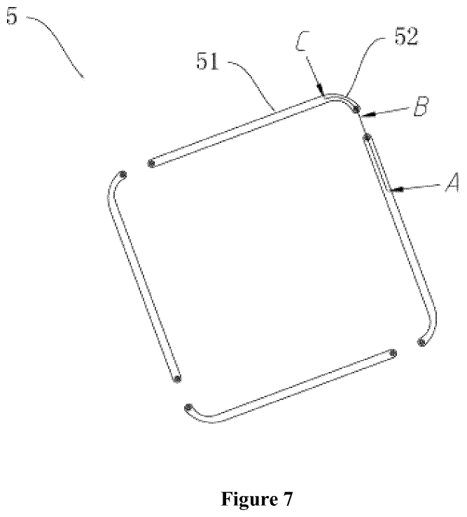

An automatic folding blade type fan mounting frame structure is different from Embodiment 1 in that, as FIGS. 5 and 7 shown, the fan blade mounting frame 2 is a circular plate, and there are at least four mounting holes 20. The reinforced convex ribs 21 are arc-shaped long strip structures. The arc center of the reinforced convex ribs 21 is roughly the same as the center of the circle of the fan blade mounting frame 2. Each section of the reinforced convex ribs 21 surrounds as a circle. The mounting holes 20 are arranged in the direction where the reinforcing convex ribs extend. The above is used to improve the strength of deformation resistance of the entire fan blade mounting frame 2.

Preferably, the reinforcing convex ribs 21 are provided with a number of supporting convex ribs 24 extending in the radial direction to enhance the strength of deformation resistance of the entire fan blade mounting frame 2.

The above are only embodiments of the present utility patent, and common knowledge such as the well-known specific structures and characteristics of the solutions are not described in detail here. It should be pointed out that for those skilled in the art, several deformations and improvements can be made without departing from the structure of the present utility patent. These should be also regarded as the protection scope of the present utility patent and will not affect the implementation effect and the practicality of the present utility patent. The scope of protection claimed in this application shall be based on the content of the claims, the specific embodiments and other records in the description may be used to interpret the content of the claims.

1. An automatic folding blade type fan mounting frame structure, comprising a main machine, wherein the main machine is provided with a rotatable fan blade mounting frame; the rotatable fan blade mounting frame is provided with at least two mounting holes distributed along its circumference, and fan blade assemblies capable of rotating relatively are arranged on the mounting holes of the fan blade mounting frame; the fan blade assemblies comprises blades extending away from rotation center so that the fan blade assemblies expands outward under the action of centrifugal force when the fan blade mounting frame rotates; the fan blade mounting frame is provided with a folding structure capable folding the fan blade assemblies when it stops rotating; tie rods are arranged between two adjacent fan blade assemblies, and two ends of the tie rods are respectively connected to eccentric positions of the two fan blade assemblies, so that each fan blade assembly pull the adjacent fan blade assemblies to rotate synchronously when rotating; the tie rod further comprises a straight section and an arc section, a center line AB of the straight section and a center line BC of the arc section; when the fan blades in unfolded state, the center line BC of the arc section of one tie rod is tangent to the center line AB of the straight section of another adjacent tie rod; the fan blade mounting frame is provided with reinforcing convex ribs between two adjacent mounting holes, wherein the reinforcing convex ribs are in a shape of a long strip and its two ends are respectively close to the two adjacent mounting holes.

2. The automatic folding blade type fan mounting frame structure according to claim 1, wherein the fan blade mounting frame is plate-shaped and arranged continuous flanges on its edges.

3. The automatic folding blade type fan mounting frame structure according to claim 1, wherein the fan blade mounting frame is a triangular plate with three mounting holes respectively located on vertices of the triangular plate; the fan blade mounting frame is provided with transition convex ribs around the mounting holes; the transition convex ribs and reinforcing convex ribs are arranged alternately and connected end to end to form a ring-shaped structure.

4. The automatic folding blade type fan mounting frame structure according to claim 3, wherein the transition convex rib is an arc-shaped long strip structure, which is concentric with the mounting hole.

5. The automatic folding blade type fan mounting frame structure according to claim 1, wherein the fan blade mounting frame is a circular plate; there are at least four mounting holes, and the reinforcing convex ribs are arc-shaped long strip structures.

6. The automatic folding blade type fan mounting frame structure according to claim 1, wherein the reinforcing convex ribs are provided with a number of supporting convex ribs extending in radial direction.

7. The automatic folding blade type fan mounting frame structure according to claim 1, wherein the folding structure further comprises a rotating base connected to the fan blade assemblies, where the rotating base is connected to a return spring; one end of the return spring is connected to the rotating base and another end is connected to the fan blade mounting frame.

8. The automatic folding blade type fan mounting frame structure according to claim 1, wherein the fan blade assemblies further comprises a sliding base connected to the blade, and the sliding base is arranged between the blade and the fan blade mounting frame.

9. The automatic folding blade type fan mounting frame structure according to claim 1, wherein the fan blade mounting frame is provided with a protrusion in the middle for connecting to the mounting boss of the main machine.

10. The automatic folding blade type fan mounting frame structure according to claim 1, wherein the fan blade mounting frame and the reinforcing convex ribs are an integrated structure formed by stamping of metal.

11. The automatic folding blade type fan mounting frame structure according to claim 2, wherein the fan blade mounting frame is a triangular plate with three mounting holes respectively located on vertices of the triangular plate; the fan blade mounting frame is provided with transition convex ribs around the mounting holes; the transition convex ribs and reinforcing convex ribs are arranged alternately and connected end to end to form a ring-shaped structure.

12. The automatic folding blade type fan mounting frame structure according to claim 11, wherein the transition convex rib is an arc-shaped long strip structure, and the arc shape of the transition convex rib is concentric with the mounting hole.

13. The automatic folding blade type fan mounting frame structure according to claim 2, wherein the fan blade mounting frame is a circular plate; there are at least four mounting holes, and the reinforcing convex ribs are arc-shaped long strip structures.

14. The automatic folding blade type fan mounting frame structure according to claim 2, wherein the reinforcing convex ribs are provided with a number of supporting convex ribs extending in the radial direction.
